(19) United States
(12) Patent Application Publication
(10) Pub. No.: US 2010/0271458 A1
(43) Pub. Date: Oct. 28, 2010

(54) Multi-Input-Driven Entertainment and Communication Console With Minimum User Mobility

(76) Inventors: Yashesh Shethia, Thane (IN); Kiran Khalap, Mumbai (IN); Anand Bhaskar Halve, Mumbai (IN); Vivek Subramanian, Orinda, CA (US)

Correspondence Address: BARNES & THORNBURG LLP, P.O. BOX 2786, CHICAGO, IL, 60690-2786, US

(21) Appl. No.: 12/768,864

(22) Filed: Apr. 28, 2010

Related U.S. Application Data
(60) Provisional application No. 61/173,304, filed on Apr. 28, 2009.

(51) Int. Cl. H04N 5/66; G06F 3/033; H04N 7/15

(52) U.S. Cl. 348/14.08; 348/739; 345/158; 348/E07.083; 348/E05.133

(57) ABSTRACT

An information console is a system for providing information, entertainment and communication capabilities to any person or hospital patients, and those recovering at home comprising of a user interface for enabling the patient to interact with the system, a display unit for displaying video as well as providing visual feedback to the patient, an audio unit for outputting audio as well as providing audible feedback to the patient and a software system for responding to patient requests provided via the user interface to control the display unit and the audio unit. Also the same system is used by the persons undergoing recuperation from illness or injury at home for providing entertainment and communication capabilities.

This application claims priority to U.S. Provisional Application Ser. No. 61/173,304, filed Apr. 28, 2009, which is herein incorporated by reference in its entirety.

### FIELD OF THE INVENTION

This invention relates to electronic entertainment and information provision and more particularly to a system for providing the same. (including digital audio, video, recreation, gaming and communication activities), for persons with disabilities, as well as persons who are emotionally and/or physically weak.

### BACKGROUND OF THE INVENTION

The emotional health of medical patients is strongly related to their recuperation from injury, disease, and medical treatments. Patients who suffer from poor emotional status usually suffer from prolonged recovery periods and degraded quality of life. Patients who suffer from boredom and isolation from friends and family often show degraded mental condition when in a hospital, for example.

Modern hospital rooms contain numerous pieces of entertainment electronics, including televisions, video players, and radios. Additionally, patients often bring their own entertainment, including portable audio players, video games, and books.

Many of these systems, however, are not suitable for use by persons in hospitals, who in many cases suffer from limited range of motion, degraded motor skills, degraded visual acuity, etc. Additionally, the complexity of interacting with a large range of such devices through numerous remote controls, keypads, and physical interfaces is often challenging, particularly for individuals in hospitals. This is problematic, since access to entertainment is critical to prevent patients from being driven to boredom, and, in severe cases, to depression. Mental engagement is key to maintaining mental health, which in turn impacts patient quality of life and mental stimulation.

From the perspective of communication with the external world, modern hospitals typically provide telephones, and patients in turn may bring their own communication devices, including cellular phones and messaging devices. These in turn may have limited usability by persons in hospitals due to limited motor skills and visual acuity. Communication with a patient's normal world is highly critical to patient quality of life.

The ability to communicate with friends and relatives impacts patients' emotional health. The ability to maintain contact with normal employment related contacts is also important to ensure management of disengagement-related stress.

Finally, from the perspective of a patent's mental engagement, modem hospitals typically do not provide any specific electronic devices in this regard. Patients in turn may bring their own entertainment electronics such as video games, etc., though these may not be suitable for persons with disabilities and/or limited motion or visual acuity. Additionally, feedback from the use of these devices may not be usable by health professionals to monitor patient progress, etc.

One may expect a similar handicap being developed in the case of a person suffering from prolonged illness or recuperation even in homes with no other human being accompanying the ‘patient’. Long periods of loneliness and a sense of isolation from friends and family can aggravate even a mild physical handicap.

What is needed, therefore, is an electronic device offering entertainment and communication capabilities for patients in hospitals as well as homes. Such a device should provide patient-accessible communication and entertainment through an appropriate user interface. This interface should be adapted for use by patients with limited mobility, motor skills, and/or visual and audio acuity. Such a device could thus be used to ensure the mental and emotional well-being of patients in hospitals and homes.

Furthermore, through use of appropriate feedback to electronic games, etc., such a device could be used to actively monitor the health and recovery of patients, and, indeed, aid recover through the use of systematically designed mental and motor skill exercises.

The use of the device can be monitored, thereby controlling/limiting the number of times the patient receives incoming or outgoing communication.

The rest of the family, even though not on location in the city or nation can stay in touch with the ‘patient’ thus creating a ‘network of well-being’.

### SUMMARY OF THE INVENTION

The present invention is directed to an entertainment and communication console for use by patients in hospitals and persons recovering at home. The console is generally provided with a user interface suitable for use by patients with limited mobility, reduced motor skills, and/or degraded visual and/or auditory acuity such as would be the case for many patients in hospitals or those with prolonged periods of recovery in residences. The user interface may be designed to be customizable to match the specific skills and needs of individual patients. The console generally controls hardware to provide patients with entertainment, information, and communication capabilities, including the ability to watch television and videos, listen to music, communicate with the external world, and entertain themselves and exercise themselves through use of electronic games and mental exercise routines.

### BRIEF DESCRIPTION OF THE FIGURES

The accompanying figures, which are included to provide a further understanding of the invention, are incorporated in and constitute a part of this specification, illustrate embodiments of the invention and together with the detailed description serve to explain the principles of the invention. No attempt is made to show details of the invention in more detail than may be necessary for fundamental understanding of the invention and various ways in which it might be practised.

FIG. 1: Shows the four way joystick with push to select.

FIG. 2: Shows microphone used as an audio input device for the user interface by way of voice commands.

FIG. 3: Shows the Camera with optical eye movement sensor.

FIG. 4: Shows the touch screen LCD.

FIG. 5: Shows the Main Console and processor unit.

FIG. 6: Shows the multimedia unit for mounting below main unit.

FIG. 7: Shows the motorised Stand-alone projection unit.

FIG. 8: Shows the Human Interface device (HID) air.

### DETAILED DESCRIPTION

The present invention is directed to an entertainment and communication console for use by patients in hospitals and persons recovering at home or by any other person. The console is generally provided with a user interface suitable for use by person with limited mobility, reduced motor skills, and/or degraded visual and/or auditory acuity such as would be the case for many patients in hospitals or those with prolonged periods of recovery in residences. The user interface may be designed to be customizable to match the specific skills and needs of individual person or patients. The console generally controls hardware to provide patients with entertainment, information, and communication capabilities, including the ability to watch television and videos, listen to music, communicate with the external world, and entertain themselves and exercise themselves through use of electronic games and mental exercise routines.

In addition, the console may be capable of monitoring the patient health as well. For example, the console may be equipped to monitor patient pulse, heart rhythm, blood pressure, and other body health parameters known to one of skill in the art.

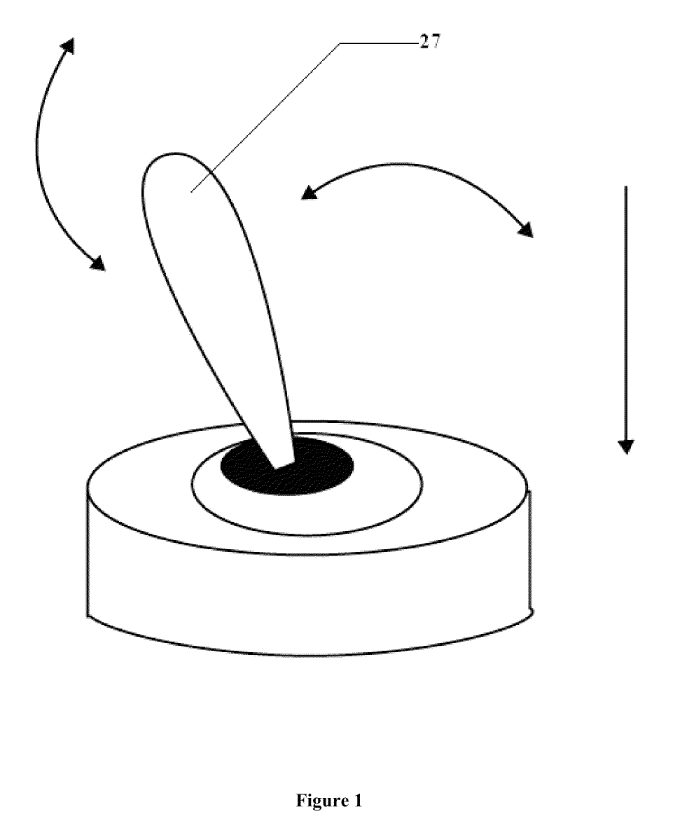

Four-way joystick: (FIG. 1) The Four-way joystick allowing left-right and up-down movement for any cursor or selection pointer on screen through a push (27). The joystick can be pushed down once (pressed) to make a selection or twice to cancel a selection. The joystick/push (27) can easily be controlled by the user's finger/s.

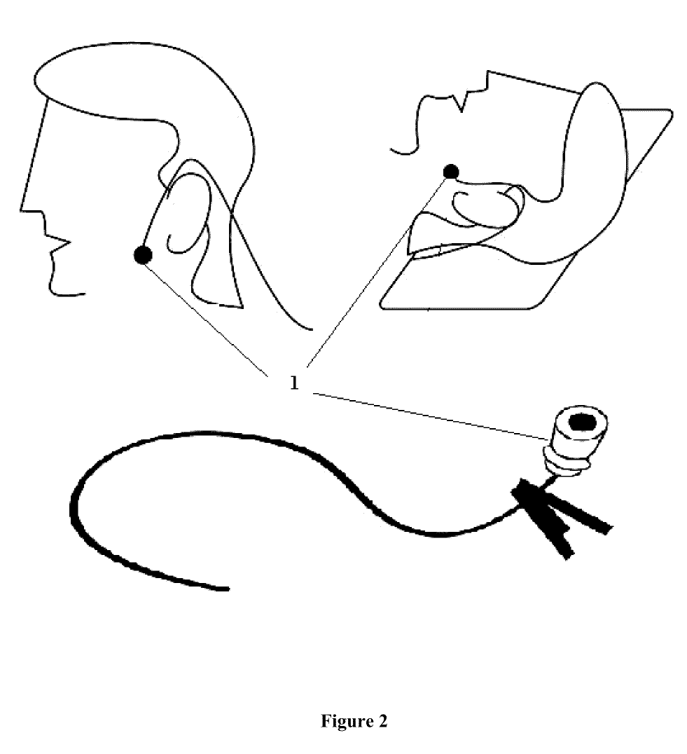

Microphone: (FIG. 2) The microphone (1) would be used as an audio input device with allows users to have conversations during basic or video telephony. The microphone will be also used by the user to give voice commands while playing games or surfing the internet. This would also allow the user to control of the entire user interface by way of voice commands.

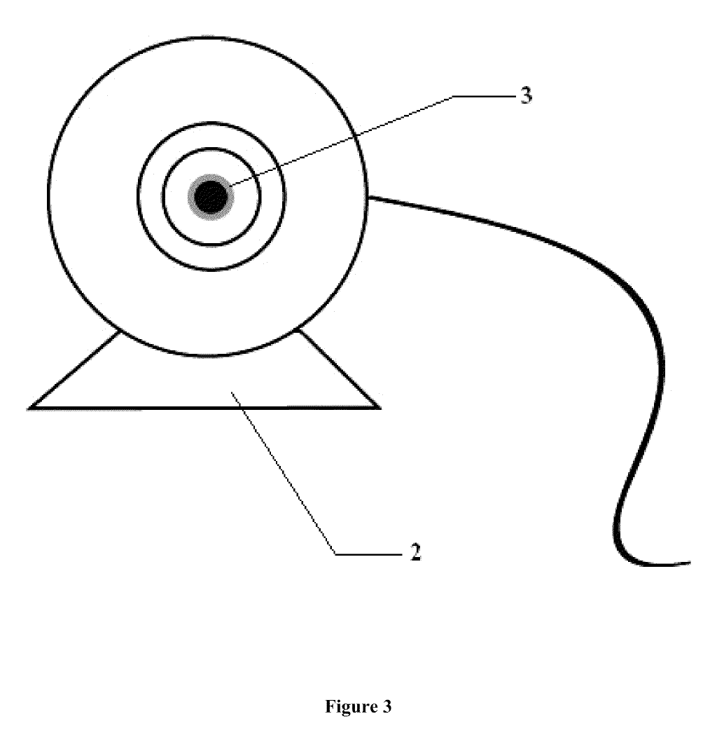

Camera with optical eye movement sensor: (FIG. 3) This device has a standard web camera (2) and well as a optical-eye movement sensor (3). The optical-eye movement sensor (3) can detect movement of the human eyeball, and this can be used as a pointing device or to move objects and items during gaming. The camera (2) can be moved on a pivot, by hand, to point it towards the user's face.

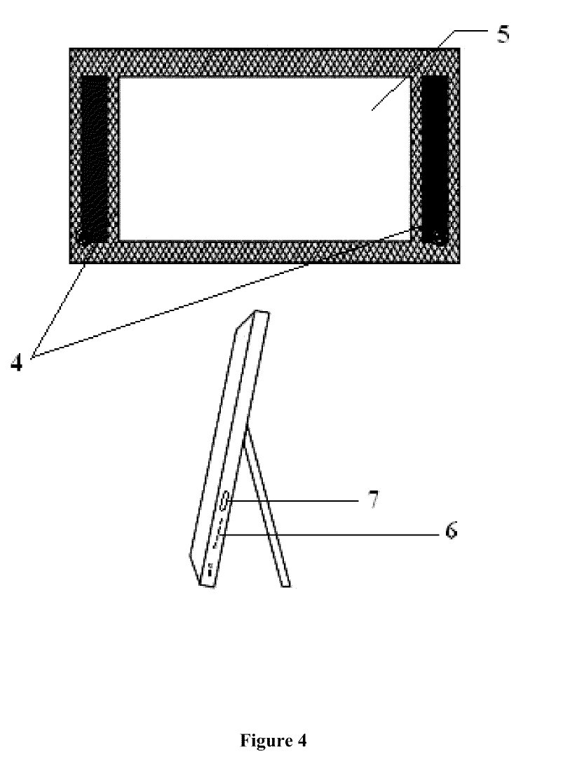

LCD screen: (FIG. 4) This device is a basic touch screen LCD screen (5) with audio speakers (4) on either side of the LCD screen. The LCD screen in activated by touching, and basic functions such as brightness and color controls and well as selecting and or navigating a menu can be done through touch. It also has a memory slot (7) and the connectivity slot (6). The speakers all audio to be streamed, connected to the source with wires, as well as allows wireless streaming, connecting to the source with use of Bluetooth or alternate streaming technology. Various forms of still and video content can be shown on the screen.

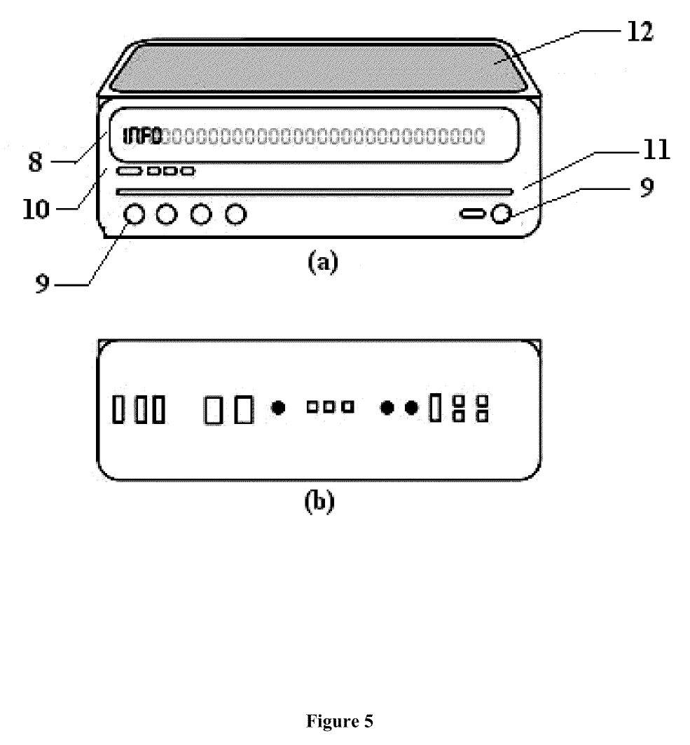

Main Console and processor unit: (FIG. 5) This unit is the brain or the console which houses the all the hardware to control all functions of this device. The console would also house the memory unit; name the hard drive (11) as well as a DVD/Blue ray drive. The LED display (8) on the front panel (a) is used as the multi-function display, which to show the status of the device or the functions currently being undertaken. The LED indicator lights (10) would show operations of power on, power off, or when the processor is being used or the DVD accessed. It also has the disk drive slot (11) for inserting the discs. The buttons (9) on the front panel (a) consist of power ON and OFF, eject, forward and back function of the track. These also allow the user to control the volume of the satellite speakers and the basic functions of the display.

The rear panel (b) of the console has the ports for connecting various inputs and outputs such as audio and video, internet through a LAN, USB 2.0 ports. The console also supports wireless internet. The console also features an HDMI output.

There is a provision to insert a GSM sim card to allow basic telephony and other network dependent functions to give add the functionality of a mobile phone. This module will also allow data transfer through a mobile network, EDGE, 3G and 4G. This features will be based on the network features of the service provider whose SIM has been inserted.

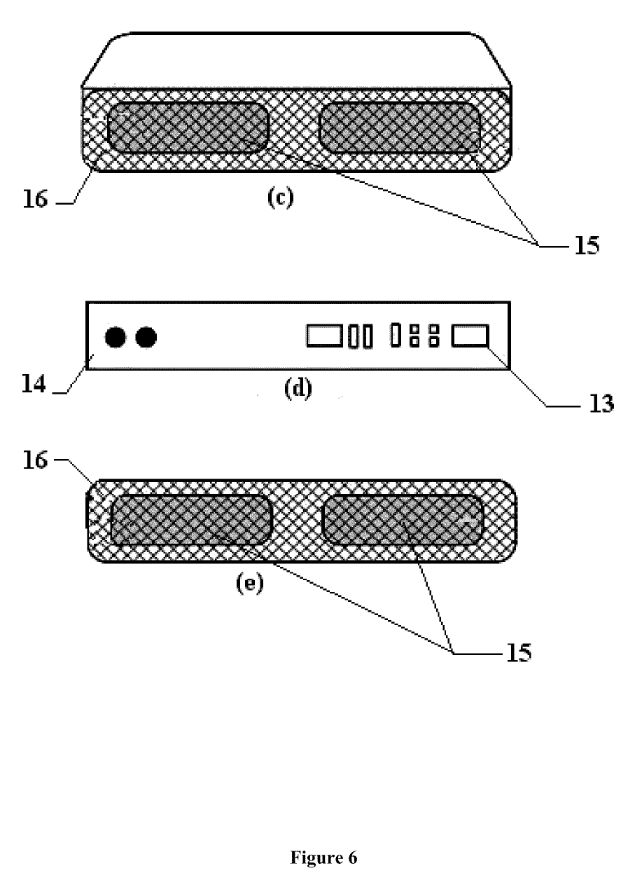

The Multimedia Unit to be mounting below the Main Unit: (FIG. 6) The multimedia unit consists of front panel (c) having speakers (15) and a wire mesh (16). The rear panel (d) comprises of connectivity ports (12) and the power supply (14) for the said system. Side Panel (e) also comprises of the wire mesh (16) and the speakers (15).

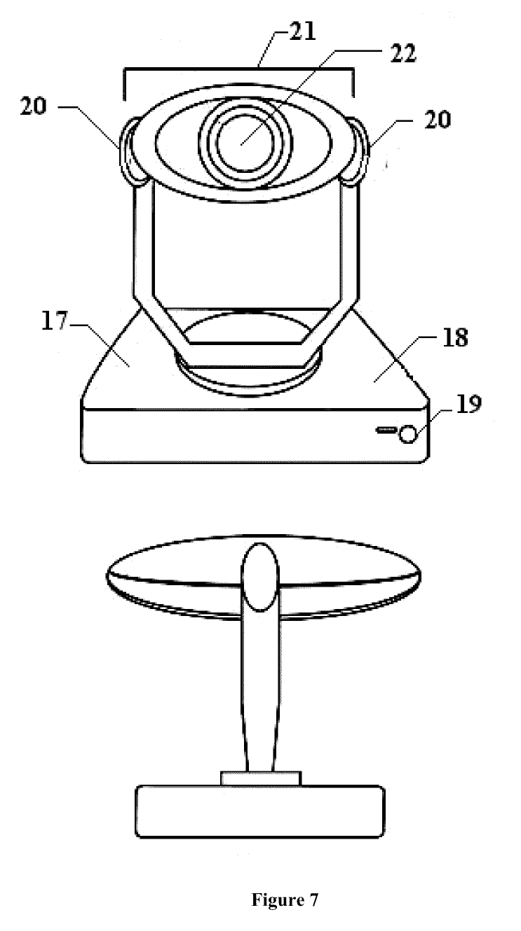

Stand-alone projection unit: (FIG. 7) Stand-alone projection unit comprising motorised pivot (20), is motorized to be able to pivot and rotate on a set axis. This device allows projection of any visual content, still or video on to a wall or a screen mounted specifically for it. The unit can also be used for video-telephony. This unit consists of a base unit (17), the arms, led indicators (19), electronics (18), Lens (22), a housing for optics and light source (21) and the display head. The system is motorised, this allows the user to be able to move the projection head left and right, and even tilt the projection to a specified degree. The unit allows for both VGA input, HDMI input, as well as a standard input from laptop or PC.

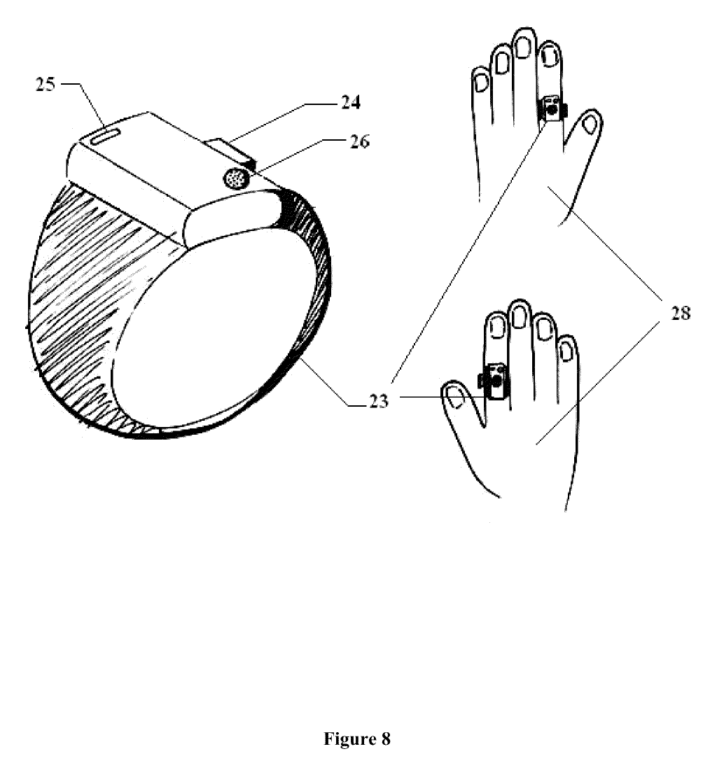

Human Interface Device (HID) Air: (FIG. 8) This is a mouse that is worn on the user's fingers like a ring. The user can control various operations by gestures or moving the hand (28) in certain directions. A wave left to right, or right to left would allow pages to be turned and music to be changed. A up and down motion of the hand (28) would allow scrolling of pages and other content. The basic features could be adapted to perform other functions: These would be software dependent. The button (24) allows the user to push to select or deselect content. The device is usable in both the left and right hand as the basic devices rotates to adapt to the users preference. The LED (25) indicates correct selections, as well as low battery. It is also provided with Mic (3).

In one embodiment, the console is controlled through a simple joystick interface designed to be usable by an individual with very limited motor skills and only limited hand usability. Through use of this interface, in this embodiment, a patient can control a television, select videos and music, enter text for electronic mail communication, launch telephonic and/or video conversations, and launch and operate video games.

In another embodiment, the console is controlled through a visually stimulated reader that monitors a patient's eyes and enables control of an electronic entertainment, information, and communication device through a patient's eye movements. Such a system would be suitable for use by patients with substantial paralysis, for example. Through use of this interface, in this embodiment, a patient can control a television, select videos and music, enter text for electronic mail communication, launch telephonic and/or video conversations, and launch and operate video games.

In a third embodiment, the console is controlled through a finger-reader system that responds to the motion of a single finger. Such a system would be suitable for use by patients with substantially limited motor skills, for example. Through use of this interface, in this embodiment, a patient can control a television, select videos and music, enter text for electronic mail communication, launch telephonic and/or video conversations, and launch and operate video games.

In a fourth embodiment, the console is controlled through a keyboard and/or mouse/joystick system. Such a system would be suitable for use by patients with essentially full use of their hands. Through use of this interface, in this embodiment, a patient can control a television, select videos and music, enter text for electronic mail communication, launch telephonic and/or video conversations, and launch and operate video games.

In a fifth embodiment, the console is controlled through a voice recognition system that is responsive to commands given orally by the patient. Through use of this interface, in this embodiment, a patient can control a television, select videos and music, enter text for electronic mail communication, launch telephonic and/or video conversations, and launch and operate video games.

Numerous types of applications and or hardware can be controlled through the user interfaces discussed above. Such applications and hardware could include any combination of a television, a digital media player for playing music and or videos, an email appliance, a telephone and/or video conferencing system, an electronic gaming system, a control system for controlling bed position, room lighting, etc., a system for communicating with hospital staff, and a system for participating in electronic exercises for stimulating the mind.

In addition, patient monitoring functionality may be implemented in all of the embodiments described above. For example, the embodiments may include such health monitoring capabilities as electo-cardiograms, pulse, blood pressure, and other such measures of physical health as would be known to one of skill in the art.

It should be noted that the embodiments above are exemplary in nature, and that suitable variations and alternatives would be apparent to one of skill in the art.

What is claimed is:

1. A system with multi-input-driven entertainment and communication console with minimum user mobility for providing information, entertainment and communication capabilities to a person comprising:
a. at least one user interface for enabling the person to interact with the system;
b. at least one display unit for displaying video as well as providing visual feedback to the person;
c. at least one audio unit for outputting audio as well as providing audible feedback to the person;
d. at least one software system for responding to person requests provided via said user interface to control the display unit and the audio unit.

2. The system as claimed in claim 1, wherein said user interface is selected from a group consisting of:
a joystick, or
a system that monitors the eye movements of the person, or
a finger motion sensor that monitors the motion of one or more fingers of the person, or
a keyboard, or
a computer mouse, or
a touch sensitive screen recognising gesture and multi-touch movements of person, or
a voice-recognition system, or
any combination thereof.

3. The system as claimed in claim 1, wherein said display unit capable of displaying is selected from a group consisting of:
television programming and video from multiple sources, stored locally or streamed from the internet, or
visual output for electronic games stored locally or streamed from the internet, or
teleconferencing or
any combination thereof.

4. The system as claimed in claim 1, wherein said audio unit is selected from a group consisting of:
outputting audio from television programming and previously recorded video entertainment content played locally or streamed from the internet, or
outputting music played locally or streamed from the internet, or
outputting audio from telephony, or
outputting audio from teleconferencing, or
outputting audio from electronic games, or
any combination thereof.

5. The system as claimed in claim 1, wherein said system is additionally capable of monitoring the health of any person by monitoring the various health parameters.

6. The system as claimed in claim 1, wherein said person is hospital patient or person undergoing recuperation from illness or injury at home or those recovering at home or may be any other person.

7. A method of interaction with the system comprising the steps of:
a. Receiving an input from a person to a user interface device;
b. Responding to said input to produce a video output;
c. Responding to said input to produce an audio output.

8. The method as claimed in claim 7, wherein said person's input is received from a group consisting of:
a joystick or a device that monitors eye movements of the person, or
a device that monitors finger motion of one or more fingers of the person, or
a standard or projected keyboard, or
a computer mouse, or
a voice recognition system, or
any combination thereof.

9. The method as claimed in claim 7, wherein said video output is received from a group consisting of:
television programming, or
recorded or live video content stored locally or streamed from the internet, or
visual output for electronic games, or
teleconferencing, or
any combination thereof.

10. The method as claimed in claim 7, wherein said audio output is received from a group consisting of:
an audio associated with television programming, or
an audio associated with recorded or streamed video, or
an audio associated with the music stored locally or streamed from the internet, or
an audio associated with a telephony, or
an audio associated with teleconferencing, or
an audio associated with electronic games, or
an audio associated with streaming, live or otherwise from the internet, or
any combination thereof.
